(19) United States
(12) Patent Application Publication
(10) Pub. No.: US 2010/0138909 A1
(43) Pub. Date: Jun. 3, 2010

(54) VPN AND FIREWALL INTEGRATED SYSTEM

(75) Inventor: Jyshyang Chen, Cupertino, CA (US)

Correspondence Address: O2M/GTPP, 55 South Commercial Street, Manchester, NH, 03101, US

(73) Assignee: O2MICRO, INC., Santa Clara, CA (US)

(21) Appl. No.: 12/569,147

(22) Filed: Sep. 29, 2009

Related U.S. Application Data
(63) Continuation-in-part of application No. 10/658,561, filed on Sep. 8, 2003, now Pat. No. 7,596,806.
(60) Provisional application No. 60/408,856, filed on Sep. 6, 2002.

(51) Int. Cl. G06F 15/16

(52) U.S. Cl. 726/11; 713/153; 726/12; 726/13

(57) ABSTRACT

The present disclosure provides an integrated VPN/Firewall system that uses both hardware (firmware) and software to optimize the efficiency of both VPN and firewall functions. The hardware portions of the VPN and firewall are designed in flexible and scalable layers to permit high-speed processing without sacrificing system security. The software portions are configured to provide interfacing with hardware components, report and rules management control.

### CROSS REFERENCE

The present application is a continuation-in-part of U.S. application Ser. No. 10/658, 561, filed on Sep. 8, 2003, now U.S. Pat. No. 7,596,806, the teachings of which are incorporated herein by reference, which claims benefit of U.S. Provisional Application 60/408,856, filed Sep. 6, 2002, the teachings of which are also incorporated herein by reference.

### FIELD

The present disclosure relates to networking systems, and more particularly, to an integrated firewall and VPN system. Utility for the present disclosure can be found in any LAN/WAN environment where VPN and/or firewall capabilities are utilized.

### SUMMARY

One embodiment of the present disclosure provides an integrated firewall/VPN system that includes at least one wide area network (WAN) and at least one local area network (LAN). An integrated firewall/VPN chipset is provided that is adapted to send and receive data packets between the WAN and the LAN. The chipset includes a firewall portion to provide access control between the WAN and the LAN, and a VPN portion adapted to provide security functions for data that moves between the LAN and the WAN. The firewall includes firewall hardware and software portions wherein at least the firewall hardware portion is adapted to provide iterative functions associated with the access control. The VPN portion includes VPN hardware and software portions wherein at least the VPN hardware portion is adapted to provide iterative functions associated with the security functions.

In one embodiment, a firewall/VPN integrated circuit (IC) is provided that includes a router core adapted to interface between at least one untrusted network and at least one trusted network to send and receive data packets between the untrusted and the trusted networks. The IC also includes a firewall system adapted to provide access control between the untrusted and trusted networks, and includes firewall hardware and software portions wherein at least said firewall hardware portion is adapted to provide iterative functions associated with access control. The IC further includes a VPN engine adapted to provide security functions for data that moves between the untrusted and trusted networks, and includes VPN hardware and software portions wherein at least said VPN hardware portion is adapted to provide iterative functions associated with the security functions.

One exemplary method according to one embodiment includes a method of providing firewall access control functions, including the steps of defining one or more access control protocols; receiving a data packet; selecting a certain number of bytes of the data packet; and processing selected bytes by using the access control protocols.

The integrated firewall and VPN of one embodiment is adapted to deliver complete suits of Internet security solutions, consolidated network management and comprehensive accounting loggings report based on traffic flow. In addition, one embodiment offers protection from Internet threats since the VPN tunnel connection receives inherent firewall protection. Common DOS (denial of service) attacks that might compromise a stand-alone VPN gateway are detected and properly handled with the integrated firewall.

One embodiment includes embedded concurrent policies to provide fine granular security to be applied to VPN traffic, thereby providing access control for all traffic. Both firewall and VPN can share the same user identification, and therefore individuals and predefined groups can have the same level of security services to access the resources to which they are entitled.

Database updates and security policy management can be simultaneously applied to both VPN and firewall, which can reduce the impact latency in complicated network environments and provide centralized management and simpler configuration of the system. Therefore, network management does not have to maintain user identification across multiple systems.

The present disclosure firewall/VPN integrated system can control bandwidth management by every individual policy. By adjusting firewall policies the present disclosure also can efficiently effect the VPN channel bandwidth management.

Further security can be implemented by integrating the policy based NAPT (Network Address Port Translation) with tunnel mode of encapsulation in IPsec VPN.

It will be appreciated by those skilled in the art that although the following Detailed Description will proceed with reference being made to preferred embodiments, the present disclosure is not intended to be limited to these embodiments. It should be understood from the outset that the present disclosure shall make use of the terms “software” or “modular processes”, and the such terms shall be construed broadly as encompassing one or more program processes, data structures, source code, program code, etc., and/or other stored data on one or more conventional general purpose and/or proprietary processors, that may include memory storage means (e.g. RAM, ROM) and storage devices (e.g. computer-readable memory, disk array, direct access storage). Alternatively, or additionally, such methods or modular processors may be implemented using custom and/or off-the-shelf circuit components arranged in a manner well understood in the art to achieve the functionality stated herein.

### BRIEF DESCRIPTION OF THE DRAWINGS

Other features and advantages of the present disclosure will become apparent as the following Detailed Description proceeds, and upon reference to the Drawings, wherein like numerals depict like parts, and wherein:

FIG. 1 is a generalized block diagram of the firewall/VPN integrated system according to one embodiment of the present disclosure.

FIG. 2 is a functional block diagram of the firewall/VPN integrated system according to one embodiment of the present disclosure.

FIG. 3 is an exemplary block diagram of the software and firmware components of the firewall/VPN integrated system according to one embodiment of the present disclosure.

FIG. 4 is a detailed network-level block diagram of an exemplary implementation of the firewall/VPN integrated system according to one embodiment of the present disclosure.

FIG. 5 is a functional block diagram of the firewall/VPN integrated system according to one embodiment of the present disclosure.

### DETAILED DESCRIPTION OF EXEMPLARY EMBODIMENTS

Reference will now be made in detail to the embodiments of the present disclosure. While the disclosure will be described in conjunction with the embodiments, it will be understood that they are not intended to limit the disclosure to these embodiments. On the contrary, the disclosure is intended to cover alternatives, modifications and equivalents, which may be included within the spirit and scope of the disclosure as defined by the appended claims.

Furthermore, in the following detailed description of the present disclosure, numerous specific details are set forth in order to provide a thorough understanding of the present disclosure. However, it will be recognized by one of ordinary skill in the art that the present disclosure may be practiced without these specific details. In other instances, well known methods, procedures, components, and circuits have not been described in detail as not to unnecessarily obscure aspects of the present disclosure.

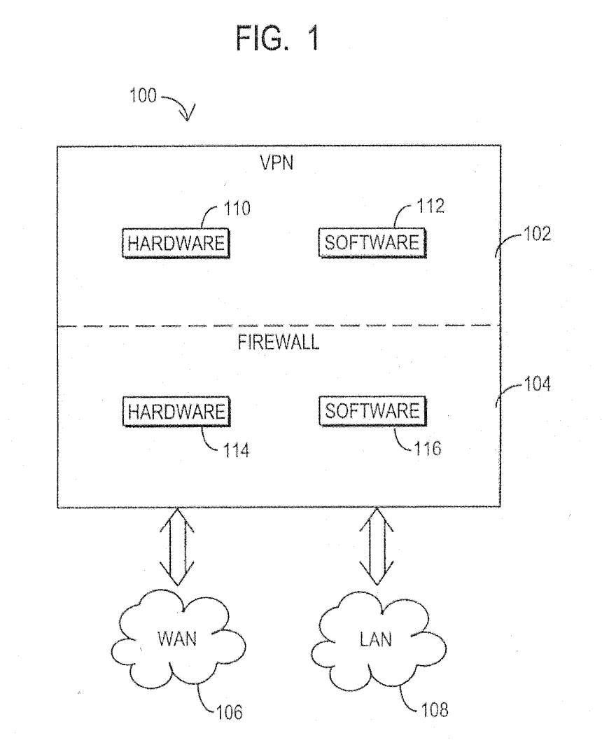

FIG. 1 depicts a generalized block diagram of the firewall/VPN integrated system 100 according to one embodiment of the present disclosure. In one embodiment, the system 100 includes a VPN portion 102 and a firewall portion 104 that operate to monitor traffic between the WAN 106 and LAN 108. The VPN portion 102 generally operates to provide secure encryption/decryption of packet data between gateways on the WAN side. The VPN portion includes hardware 110 and software 112 to provide encryption/decryption using conventional and/or proprietary encryption/decryption algorithms (processes), as is well understood in the art. The firewall portion 104 monitors traffic between the LAN and WAN (in a manner well understood in the art) and generally includes both hardware 114 and software 116 to monitor traffic. One embodiment optimizes hardware and software to achieve both integrated functionality of 3 VPN and firewall functions, and to increase performance of the data flow on a system wide level.

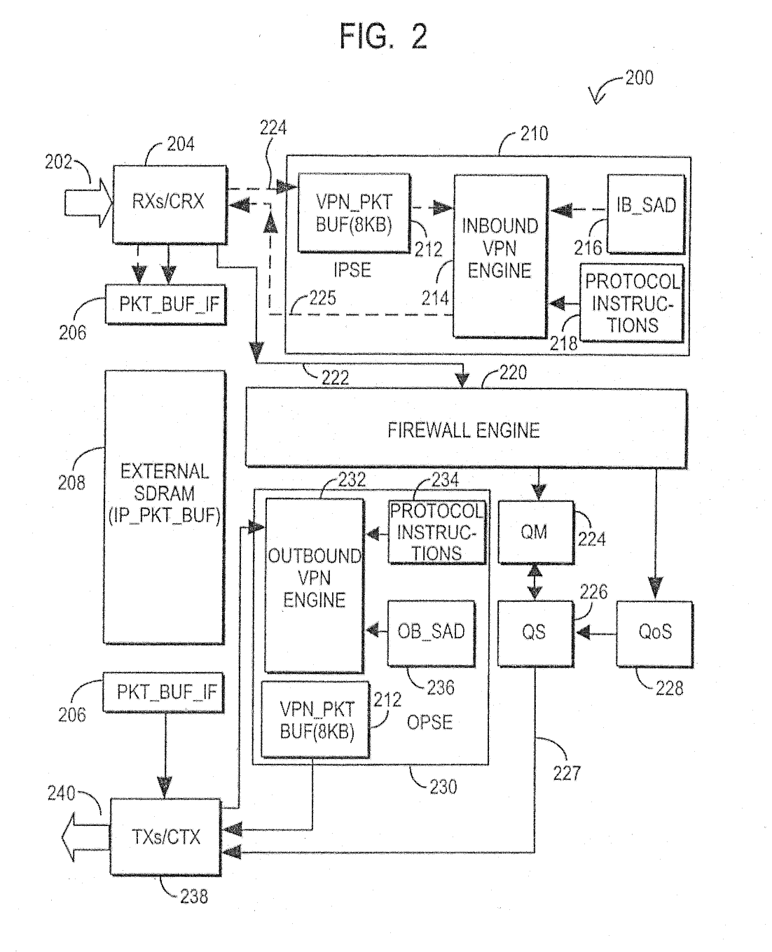

FIG. 2 depicts a functional block diagram 200 of the firewall/VPN integrated system according to the present disclosure. The diagram 200 depicts data flow and processes for both the VPN portion and the firewall portion. Incoming data (in the form of a packet stream) 202 from the LAN or WAN is received by the network interface 204. In one embodiment, the interface 104 is adapted to interface with the protocols used in the particular LAN/WAN environment, as is understood in the art. The interface 204 receives a packet stream and places the data into a packet buffer memory 206. Additionally, the system may be configured with additional and/or external memory 208 (e.g., Flash memory, SDRAM, etc.) which is adapted to temporarily store the packet data. In an exemplary embodiment, the external memory 208 is adapted top store IP data packets.

The interface 204 determines if the incoming data is plain text (from the LAN) or cipher text (from the WAN). If the data is plain text (meaning the data has come in from the LAN side), then the interface 204 is adapted to forward (along data path 222) a preselected number of bytes to the firewall 220. In one embodiment, the first 144 bytes of data from the packet stream are selected since these bytes contain Layer 2 through Layer 7 headers and content information. However, 144 bytes is only exemplary and may be some other preselected value, depending on, for example, the desired level of security or efficiency of the firewall. If the interface 204 determines that the incoming data 202 is cipher text (i.e., encrypted data coming in from the WAN side), then the incoming data stream is sent to the inbound VPN engine 210.

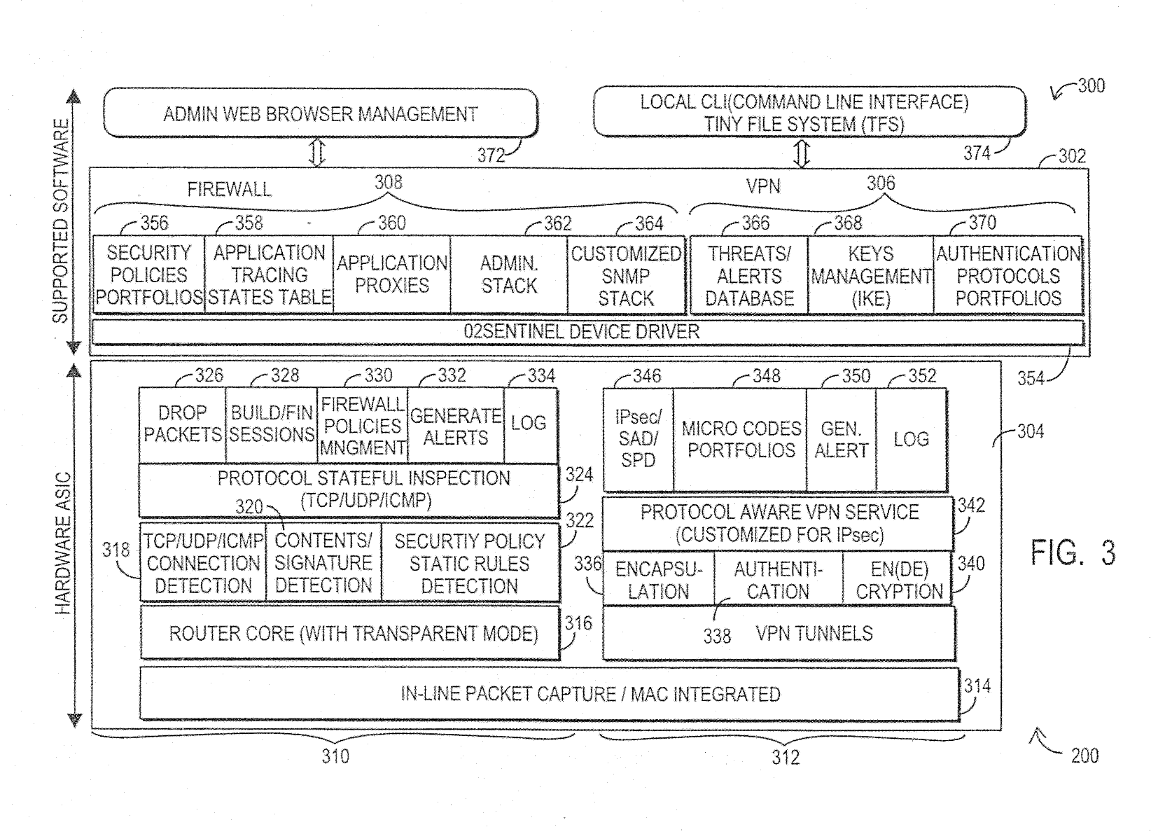

The inbound VPN engine 210 generally includes decryption and decapsulation processing to convert cipher text into a plain text IP packet. As will be described more fully below with reference to FIG. 3, the VPN portion of the present disclosure utilizes both hardware and software to enhance the efficiency of the VPN engine. The incoming data along path 224 is placed into a conventional buffer 212. An inbound VPN processor 214 processes the data to decrypt and decapsulate the data. An inbound security associate database 216 is provided that includes a database of tunnels that associate two gateways on the WAN side, in a manner known in the art. The processor 214 uses the 4 tunnel information of the database 216 to decrypt and decapsulate the incoming data. Also, protocol instructions 218 may be provided that includes microcodes to instruct the processor 214 to decrypt and/or decapsulate the data according to conventional and/or user-defined security procedures. Once the message is decrypted and/or decapsulated, the resultant plain text (IP Packet) data is sent to the interface 204 along data path 225. In the manner described above, preselected bytes (e.g., the first 144 bytes) of the data are forwarded to the firewall 220 along path 222.

The firewall 220 receives the preselected number of bytes from the interface 204 to begin the process of packet filtering and routing. As will be described more fully below with reference to FIG. 3, the firewall portion of the present disclosure utilizes both hardware and software to enhance the efficiency of the firewall. The firewall operates in a conventional manner to analyze incoming data according to preset user-defined security policies. Such security policies are well understood in the art and may include conventional and/or proprietary security policies. The firewall essentially operates to provide access control between an untrusted network (WAN) and a trusted network (LAN).

In one embodiment, the firewall 220 is adapted with appropriate hardware and software to analyze the preselected data instead of having to operate on the entire data packet. This can increase the overall speed and efficiency of the firewall. Those skilled in the art will recognize that larger portions of preselected data will increase security, but may tend to slow down the firewall processing. Therefore, one embodiment permits users to “tune” the firewall settings to meet desired security and/or speed requirements.

Once the data has passed the security policies, the present disclosure may also be adapted with quality management 224 and quality of service 226 processing. The quality management processing manages the packet buffer 206 to maintain the links between queued packets stored in the memory. Quality of service 226 operates as a packet priority scheduler and will receive information from the quality of service mapping and processor 228. Essentially, and as understood in the art, quality of service 226 analyzes the type of data coming in to determine which goes out first, based on, for example, data type (voice, IP, video, etc.) or bandwidth considerations on the network. Quality of service 226 may also be adapted to determine the best path across the network for the data.

As a general matter, if data leaving the firewall is destined for the LAN, then the quality service process proceeds as described above and upon completion transmits a control signal 227 to the output interface 238 to instruct the packet buffer 208 to release the data. If data leaving the firewall is destined for the WAN, it may require encryption/encapsulation before being forwarded along to the WAN. In that event, an outbound VPN engine 230 is provided that provides encryption and/or encapsulation of WAN outbound data. The engine 230 includes an outbound VPN processor 232 that encrypts and encapsulates the data based on instructions from the protocol 234 and the outbound security associate database 236, in a manner similar to the inbound VPN engine 210 (described above). In one embodiment, the security policies in place in the outbound security associate database may be adapted to match the security policies of the firewall 220. Once the data is encrypted it is sent to the transmission interface 230 and leaves out onto the WAN 240.

FIG. 3 is an exemplary block diagram 300 of the software and firmware components of the firewall/VPN integrated system according to one embodiment of the present disclosure. Generally, the software portions are set out at 302 and the hardware (ASIC) portions are set out at 304. The hardware and software associated with the firewall are set out at 310 and 308, respectively, while the hardware and software associated with the VPN are set out at 312 and 306, respectively. As set out above, the present disclosure utilizes hardware and software to increase overall efficiency. As a general matter, processes that are highly repetitive and/or mathematically intensive are formed in hardware, while other processes are performed using software. Each of the processes in the hardware platform 304 may comprise one or more distributed RISC-type processors adapted to perform the stated tasks, although other processor implementations are equally contemplated herein. It should be understood at the outset that one embodiment provides a layered approach to both hardware and software functionality, as indicated by the different layers depicted in FIG. 3. Of course, those skilled in the art will recognize that FIG. 3 represents only one exemplary approach, and that other layered arrangements can be made without departing from the spirit and scope of the present disclosure. Each of the blocks of FIG. 3 is described more fully below.

Referring to FIG. 3, one embodiment of the Firewall Hardware Platform 310 is discussed below.

The In-Line Packet Capture/MAC integrated block 314 is operable to receive traffic from the network, where the frame is the unit in this level. The router core 316 ensures that the packets will be forwarded according to different destination addresses and associated security measures, based upon either Firewall or VPN (virtual private network). The TCP/UDP/ICMP connection detection block 318 is adapted to determine if the state of the connection has been fully traced. It can be adapted to make hash approach then search if the coming packet has been in the traced and registered connection. When the coming packet is proven within the connection, the states of which can be fully traced, the packets can be forwarded directly to expedite this security measure. As such, the state can be closed, when the states of present connection can be fully traced and the packets are forwarded directly, to trade off for the performance of the firewall/VPN integrated system.

The Contents/Signature detection block 320 is adapted to perform real time analysis of the 144 bytes of information of an incoming data packet to determine if a limited number of patterns exists within incoming packets, which may include recognized codes of viruses or worms. The Security Policy static rules detection block 322 is adapted to provide a static packet filtering function. The static filtering feature is intended to refer to packet filtering that involves an investigation of a current single packet instead of looking for a correlation or a context of preceding or subsequent packets. The Protocol Stateful Inspection (TCP/UDP/ICMP) block 324 is adapted to recognize the connection by inspecting its protocol's dynamics, so different applications using TCP or UDP, or ICMP can use this block to analyze incoming data. After the analysis contribution of this component, it will communicate with TCP/UDP/ICMP connection detection component to work out the speed connection check.

The drop packets block 326 receives results from the lower layers (324, 318, 320 and 322) that may be used to generate pass or deny decisions according to security policies. The Build/Fin Sessions block 328 parses and tracks the beginning and ending of a connection or session. Since the starting of a TCP connection involves states transitions for two ends of a connection, the security of a TCP connection can rely on these states transitions. Using such tracking, one embodiment utilizes hardware speed to monitor and look up the connection status which comprise building, looking up and tearing down. The Firewall Policies Management block 330 generally manages the hardware storage of security policies, which may include internal memory storage. The generate alerts block 332 generates specific events for alerts by creating associated Interrupt events to a software stack. The alerts can be generated by the generate alerts block 332 according to different security policies or setup rules. A statistical results based on different security policies or setup rules may be individually calculated by the software to generate log reports.

Referring to FIG. 3, one embodiment of the VPN Hardware Platform 312 is discussed below.

The Protocol Aware VPN engine 342 includes several hardware-core embedded function parts, including the encapsulation function block 336, authentication block 338, and encryption/decryption block 340. For flexibility and security concerns, distributed RISC-oriented proprietary cores may be used in this VPN engine. By changing the micro-codes for each individual micro-processor, the different tasks executed in the VPN engine may be different depending on the protocols required, for example higher performance of IPsec protocol for IPv4 or IPv6.

The IPsec SADB/SPD block 346 includes hardware storage of IPsec tunnel attributes data base, and rule selectors. At least some of the packets within the tunnel needs to reference this database to determine actions to employ regarding this packet for IPsec protocol. This component may be optimized for IPsec protocol purpose. The contents of the database are acquired from the tunnel negotiating via an IKE process. The Microcodes profiles block 348 holds different micro-codes for different security protocols. The generate alert block 350 is adapted to generate alerts based upon selected criteria, for example, the live time expiring of a tunnel, an encounter with malicious encrypted packets, unsuccessful processing of packets due to tunnel synchronization, etc. The Log 352 hardware statistics supports general logs VPN related and by every tunnel base.

Referring again to FIG. 3, software platform 304 is discussed below.

The device driver 354 provides an interface between software 302 and hardware 304. The securities policies portfolios block 356 provides the management software for the deployment of security policies. The Application tracing states table block 358 is the software component to provide detailed investigation to see which applications use the TCP/UDP/ICMP protocol. Then according to different application requirements and its stateful inspection, this software component may create associated gates in the firewall system 8 for secure protection purposes. The Application Proxies block 360 is generally located at the Kernel level to provide more detailed investigation according to application level. This process can re-assemble the flows and contexts of in-line network traffic to make more detailed content analysis or pattern searching for the database of virus or worms, or filter unwanted commands. The Administrative software stack 362 executes the administration tasks for the system. These tasks include firewall systems and VPN engine systems. The SNMP (small network management protocol) stack 364 is provided to execute the SNMP according to general RFC requirement. This component is the interface for the general network device or network software stack to get the status or any statistics or logs in the system.

The Threats/Alerts database 366 is provided to collect threats or alerts from hardware and software. These events can be stored in database form, to permit easy interface with a database application deployed above this kernel. The-7 Auto Keys/SA Management (IKE/ISAMP) block 368 provides the main protocols of IPsec to manually or auto negotiate keys and SA (security attribution) according to the RFC2408 requirement. This component is associated with IPsec functions. The Authentication protocols portfolios 370 is provided to support IPsec authentication requirement. It may include message authentication protocol (HMAC-96) [RFC-2104] within ESP (Encapsulating Security Payload) and AH (Authentication Header). The goal of authentication algorithm is to ensure that the packet is authentic and can not be modified in transit.

The Administrative Web Browser Management provides a Web based management GUI (graphic user interface) component. In the exemplary system, the system general CPU will host the web server under HTTPS protocol, the management web page will be stored in this web server. All configuration and management processes for the system can be collaborated to be shown on the web page. By using socket layer SSL (Secure Sockets Layer), the management web page can be browsed remotely (in WAN host), or through a local secure LAN host with an encrypted connection (i.e. the connection uses the chosen encryption algorithm to provide high degree privacy). The Local CLI (command line interface)/Tiny File System(TFS) 374 is adapted to provide local access with command line and configuration files interaction.

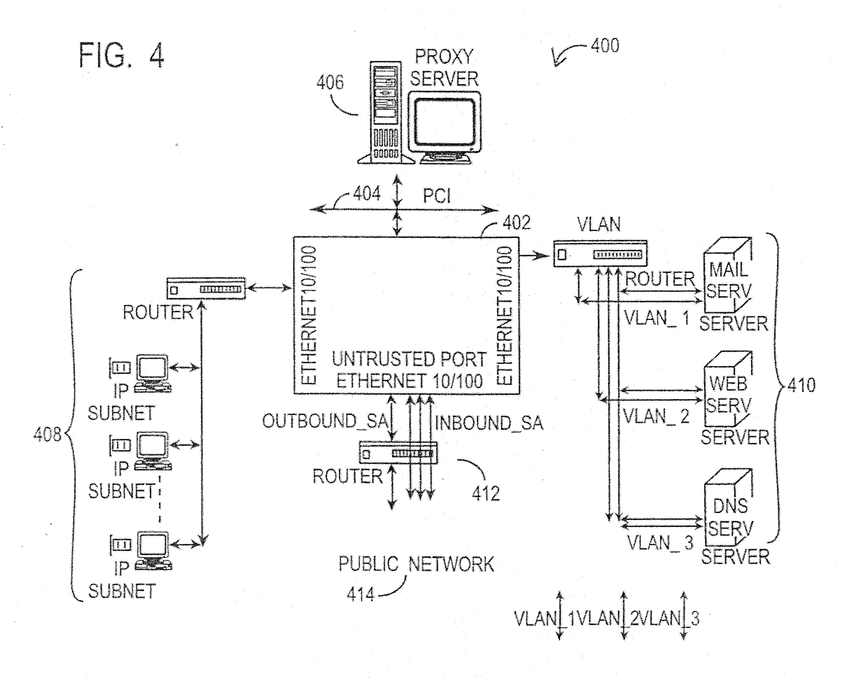

FIG. 4 is a detailed network-level block diagram 400 of an exemplary implementation of the firewall/VPN integrated system according to the present disclosure. The firewall/VPN system 402, as described above, is employed as the access control module between the public network (WAN) 414 and one or more LAN networks 408 and/or 410. In this example, the system is employed on a proxy server 406 via a conventional PCI bus 404. The router and other components of this figure should be self-explanatory to those skilled in the art.

System Overview And Specific Exemplary Implementations

As a summary, the following description details the present disclosure with reference some specific embodiments as depicted in FIGS. 2, 3 and 4. These embodiments are only exemplary and not intended to limit the present disclosure. The present disclosure provides a system-on-chip solution for high performance Firewall with integrated VPN. The firewall portion may be implemented as a coded system to provide multiple layers of static/dynamic packer filtering engines with different granularity of real-time policies inspection and flexible rule policies management. Besides the static/dynamic packet filtering for the sophisticated rule inspection, one embodiment includes a match engine for “Stateful Inspected” of TCP/UDP connection. The present disclosure can therefore be adapted to specifically expedite packet Filtering functions for the packets within established TCP/UDP connection.

In one embodiment, for the rare virus or worms with deep dangerous content over the 144 bytes range which the hardware packet filtering system may not be able to cover or handle, the system then routes packets, along with the pre-analysis results, to Protection Proxies run on a CPU (or NPU). In one embodiment, the protection proxies use a hardware engine to analyze the header and contents and includes pre-analysis processing, thereby reducing the working load of CPU (or NPU) in the analysis or processing of individual packets.

Using hardware, the firewall of the present disclosure can be adapted to include 3 Gbs Ethernet link wire-speed and ˜200 Mbs 3DES VPN and IPsec to fit all aspects of high security demands in modern network infrastructures.

Exemplary functionality of various components of the hardware and software are described below:

1. Router Core and Configure Ports.

In one embodiment, the router core 316 provides the basic routing function to multiple logic ports in response to different packets. For example, as depicted in FIG. 4, the system 402 can be connected to four different ports: an untrusted port which is connected to Internet router, a trusted port, a DMZ port, a CPU host port and an optional NPU port. Every port has its own IP level subnets (except the NPU port which may be configured in manually in the routing table). To make use of the high processing bandwidth of the present disclosure, the port structure may be adapted to provide two configuration settings, for example, one Gbs port or multiple 10/100 Mbs ports. There are two kinds of ports adapted to handle untrusted traffic and trusted traffic. If these two flexible ports are configured for 10/100 Mbs, the ingress ports will be aggregated by the router and processed as a single logical port. Likewise for egress condition, the ports may be logically aggregated as one port, where the choice of output port may be made according to the addresses of the egress packets.

2. Flexible and Scalable Four Layer Firewall System.

The firewall includes three layers of hardware oriented static/dynamic packet filtering engines, and one layer of customized virus or worms detection proxies. Every layer of this protection system has its own features and contributes different level security shields.

The first layer is a Header Match packet filtering Engine (HME for short) which mainly handles pattern match for inspecting header of a packet, which may comprises OSI Layer 2, Layer 3, and Layer 4 headers. Since the header fields have some degree of granularity and expectation in header pattern, this layer of packet filtering is generally more straight-forward. Therefore, rules compilation and management in this layer can be easily implemented, thereby reducing the efforts of the IT user. Without sacrificing the high bandwidth performance for ease of implementation, this layer is adapted to handle traffic in a sustained Gbs (giga bits per second) bandwidth state.

In one embodiment, for viruses and worms not identified by the first layer (HME), the present disclosure includes a second layer in the firewall, embedded with a Contents Match hardware packet filtering Engine (CME for short). This engine analyzes the 144 bytes, which is deeper than what the Header Match packet filtering Engine does.

The third layer in the firewall system includes different sets of application proxies run in the CPU (or NPU). For the inherent limitation of pure hardware packet filtering engines, it can not cover the rare pattern detection need to locate the patterns over 144 bytes. Even this deep third layer protection provided in CPU software proxies is employed, the “pre-analysis” results from analyzing the contents of the first layer and second layer still can make much contribution and be combined with the results of the deep third layer protection when a packet needs to forward to CPU port. This architect approach can tremendously off-load the processing demands from a general CPU which is running different proxies in the case of deeper layer virus detection.

A Session Match Engine (SME) is provided as the fourth layer in firewall system. The SME includes an embedded Session Look Up Table which stores the TCP/UDP connections setup by the “stateful inspection” logic. In one embodiment, the connection setup procedure in TCP/UDP involves three-way handshaking, the TCP/UDP handshaking control message packets are caught by the system's SME, then forwarded to the general CPU for tracking the setup progress. After the setup connection process is performed and recorded by the CPU, the connection socket address can be programmed into a Session Look Up Table for future packets received on this connection. The TCP/UDP packets flowing through this layer can be hashed and searched in this Session LookUp Table for checking if the packets are within the setup connections (sessions) so as to decide either pass or drop the packets and further to speed TCP/UDP connection checking.

All these four firmware blocks are integrated to provide high security while permitting the system to be flexible and fully scalable.

3. Protocol Aware VPN Engine

In one embodiment, in a protocol aware VPN engine, an array of micro-coded uPs are the foundation to provide the flexibility of different security protocols (in addition to Ipsec). The microprocessors include programmable instruction memory to permit updates of multi-protocol functions.

For this, high bandwidth performance is designed into the VPN engine. There are two independent pipelines for processing inbound and outbound VPN traffics. Each pipeline uses an array of micro-coded IN to execute the tasks assigned. Every pipe has one independent programmable IP for executing specific tasks assigned to the pipe and the tasks done within the work period to provide sustaining bandwidth. The VPN engine executes all kinds of VPN security functions including different micro-code programming for keeping data integrity and originality. Its primary authentication is provided by the hardware 12 specialized HMAC-MD5-96, and HMAC-SHA-1-96. In one embodiment, the primary algorithm of data confidentiality may be reliant on the hardware core of DES/3 DES, AES, so the latency of processing may be positively predicable. As it regards flexibility concerns, one pipe IP will provide one external system bus which can interface with external proprietary en(de)cryption chips without any public system bus overhead.

Also, the system may include an integrated smartcard reader, which can efficiently provide the storage of seeds for periodically generating shared keys or key pairs while establishing VPN channels phase.

The present disclosure features an Input Buffered Output Queued Architecture, which can eliminate head of line blocking problems in router operation. The input Buffer Management Unit stores the received IP packets in a modern Linked List Structure, which allows for easy access, and modification by the forwarding modules. The Output Queuing scheme also provides support for per port bandwidth management functions. These Bandwidth Management Functions are implemented as an integral part of the Output Queuing Function module. The policy-based NAT/NAPT (network address translation/network address port translation) also responds to the matched-policy to execute the relative NAT translation of the IP source address, as well as TCP/UDP ports translation and recovery.

The present disclosure also provides QoS (Quality of Service) support. In one embodiment, quality of services capability may depend on the policies setup and matched in the Policy Engine. The TOS (Type of Service) field of packet header acts as DiffServ (Different Serve) stamp and the VLAN tag, by means of which priority of every egress packet is determined or queued. Through the policy classification process and DiffServ mapping, the packet will get different queuing strategies according to its bandwidth requirements to meet its traffic management requirement.

The system supports both redundant failover and load balancing by a ports mirroring scheme and parts of BGP/OSPF route protocol. A secure tunnel requires that certain states of information be maintained and synchronized in a periodic manner. Port Mirroring communicates the state information with an alternative gateway by using one of Ethernet ports and BGP/OSPF messages transit so the switching over time needed will be kept to a minimum.

The modular software stacks of the present disclosure permit the system to operate at high efficiency. In balancing security and optimum performance trade-offs, the embedded software stacks provide several primitive proxies in its Lunix based kernel. The software can also include the “transparent proxying” or “hybrid proxying” features which automatically starts packet filtering by hardware and redirects the packets to an associated proxy. One advantage of this approach is that it is not visible from the user's perspective and they do not have to configure the system to communicate with the external services. Instead, the system intercepts the packets, and redirects the packets to the system proxy stacks by the user who configured it. With this versatile structure, the system can have the more sophisticated security measures offered by proxy with the speed performance of the hardware packet filter. Exemplary proxies included in system proxy stacks are FTP proxy, Telnet proxy, and mail proxy (POP, POPS, etc.) providing high application-aware ability with virus-preventive protection.

As it regards configuration management aspects, the software has centralized management control, which can access all components of the distributed system. For example, the software may include a Command Line Interface to provide the scripting form accommodating multiple Commands, Web-based Interface that may comprise an illustrative and intuitive GUI, a configuration file which can be created in a central controlled management station and upload to VPN gateway when needed, and an Application Programming Interface(API) to enable third-party vendors to develop management software for the network provisioning system.

Integrated features of the present disclosure include Hardware Firewall/VPN integrated ASIC chip, configuring 1 Gbs port for Enterprise level link or flexible 10/100 Mbs Ethernet ports, flexible external interface with proprietary en(de)cryption ASIC chip if applicable, PCI-66/33 MHz interface with general CPU, proprietary interface bus with NPU if applicable.

Exemplary performance features of the present disclosure include a Firewall throughput of sustained 2.1 Gbs Ethernet line speed and real-time header or content analysis, two layers of hardware packet-filtering engines adapted to use deterministic 12 clocks per packet (both Hardware packet filtering engines support dynamic packet 14 filtering scheme), TCP/UDP Connection filtering system operating at 800 Mbs, VPN throughput—630 Mbs/3DES, 1 Gbs/DES.

Exemplary Firewall System Features:

In one embodiment, the firewall system can comprise on-chip 1000 policies and scalable amount of policies which is supported with external SRAM array. Packet filtering analysis 144 bytes of contents of packet starting from IP layer in line speed, which provides contents-aware security without increasing any overhead or fixed cost. All packet filtering engines support dynamic change of policies according to received packets contents. Connection filtering engine provides stateful inspection of TCP/UDP handshake establishment to 25,000 connections, which is offered by the hardware searching in Session LookUp Table. MAC-address and ingress port ID are engaged for detection of topology changes. Policy based NAPT(network address/port translation) can translate many internal IP addresses to one external IP address for extranet VPN application. As such, the internal addresses are hidden securely. Transparent switch mode in disengaged NAT. Traffic flow and rate shaping controlled by individual policy granularity. Fine granularity and flexible policy setup prevents unlawful attacks with ICMP coven channel. High speed Denial of Service protection—defends against attacks with TCP-SYNFLOOD, Ping of Death, TearDrop, etc.

Exemplary VPN Features:

Full support IPsec security services for IPv4 traffic. Support L2TP within IPsec. Supports around 1000 on chip tunnels delivering high speed and diverse business-class capabilities for remote or oversea managed security. Authentication services with HMACMD5-96, and HMAC-SHA-1-96 in 800 Mbs. Data confidentiality with DES/3DES, and external interface bus with proprietary en(de)cryption ASIC chip. Can accommodate VLANs implemented by 801.1 Q for increased security measures.

Exemplary QoS Traffic Management Features:

Traffic shape control, Guaranteed bandwidth, and Voice over IP. Priority bandwidth DiffServ Stamp.

Other Exemplary Features of the System:

Stateful backup failover capability for mission-critical applications. Configure Gbs port or 10/100 Mbs ports, which can offer the enterprise-class bandwidth link. The multi-10/100 Mbs ports can be adapted to provide link aggregation and automatic failover for defective physical links. One embodiment is provided based on 0.15 um advanced CMOS technology.

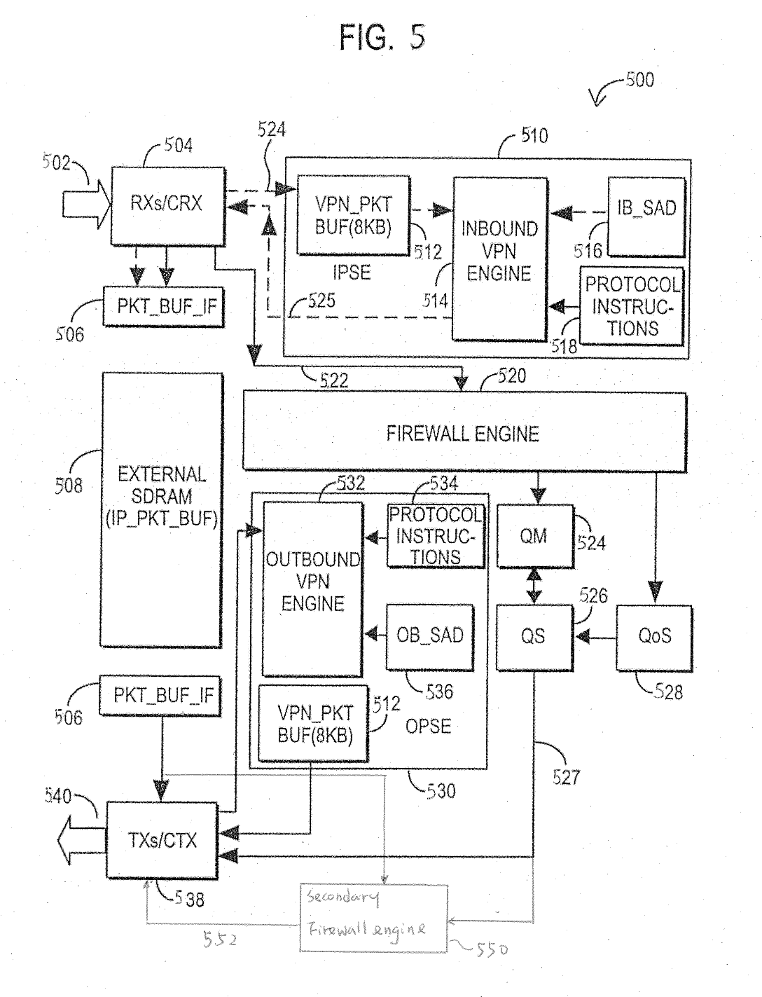

FIG. 5 depicts a functional block diagram of a firewall/VPN integrated system 500 according to another embodiment of the present disclosure. The firewall/VPN integrated system 500 shown in FIG. 5 is similar to the firewall/VPN integrated system shown in FIG. 2, wherein like numerals depict like parts. For clarity, the elements and the features of the firewall/VPN integrated system 500 that are similar to the elements and the features shown the firewall/VPN integrated system shown in FIG. 2 will not be described.

The data flow in the firewall/VPN integrated system 500 is similar to the data flow shown in the FIG. 2. Incoming data (in the form of a packet stream) 502 from the LAN or WAN is received by the network interface 504. The interface 504 is adapted to interface with the protocols used in the particular LAN/WAN environment, as is understood in the art. The interface 504 receives a packet stream and places the data into a packet buffer memory 506. Additionally, the system 500 may be configured with additional and/or external memory 508 (e.g., Flash memory, SDRAM, etc.) which is adapted to temporarily store the packet data.

As described hereinabove, the first 144 bytes or other preselected value of data from the packet stream are selected to be sent to a firewall engine 520 directly or through an inbound VPN engine 510. In the present disclosure, the firewall 520 is adapted with appropriate hardware and software to analyze the preselected data instead of having to operate on the entire data packet. This can increase the overall speed and efficiency of the firewall. Those skilled in the art will recognize that larger portions of preselected data will increase security, but may tend to slow down the firewall processing. Therefore, the present disclosure permits users to “tune” the firewall settings to meet desired security and/or speed requirements.

Once the data has passed the security policies, the present disclosure may also be adapted with quality management 524 and quality of service 526 processing. The quality management processing manages the packet buffer 506 to maintain the links between queued packets stored in the memory. Quality of services 526 operates as a packet priority scheduler and will receive information from the quality of service mapping and processor 528.

As a general matter, if data leaving the firewall engine 520 is destined for the LAN, then the quality service process proceeds as described above and upon completion transmits a control signal 527 to the output interface 538 to instruct the packet buffer 508 to release the data. If data leaving the firewall is destined for the WAN, it may require encryption/encapsulation before being forwarded along to the WAN. In that event, an outbound VPN engine 530 is provided that provides encryption and/or encapsulation of WAN outbound data. Once the data is encrypted it is sent to the transmission interface 530 and leaves out onto the WAN 540.

According to one embodiment of the present disclosure, the firewall/VPN integrated system 500 further comprises a secondary firewall engine 550. The firewall engine 520 further comprises a policy of checking the content of the packet stream. Once the first preselected value, e.g. 144 bytes, of data from the packet stream meet the policy of checking the content of the packet stream, the secondary firewall engine 550 will be activated. When the policy is met, the packet buffer 508 will be instructed to release the data to the secondary firewall engine 550.

The secondary firewall engine 550 is equipped with appropriate hardware and software to analyze the entire data packet. Once the entire date packet has passed the security policies, it may be transmitted to the output interface 538 to instruct the packet buffer 508 to release the data. Combined with the firewall engine 520, the firewall/VPN integrated system 500 is able to combine the efficient operation by analyzing the pre-selected data and the complete operation by analyzing the entire data packet.

While the foregoing description and drawings represent the preferred embodiments of the present disclosure, it will be understood that various additions, modifications and substitutions may be made therein without departing from the spirit and scope of the principles of the present disclosure as defined in the accompanying claims. One skilled in the art will appreciate that the disclosure may be used with many modifications of form, structure, arrangement, proportions, materials, elements, and components and otherwise, used in the practice of the disclosure, which are particularly adapted to specific environments and operative requirements without departing from the principles of the present disclosure. The presently disclosed embodiments are therefore to be considered in all respects as illustrative and not restrictive, the scope of the disclosure being indicated by the appended claims and their legal equivalents, and not limited to the foregoing description.

What is claimed is:

1. An integrated firewall/VPN system adapted to coupling at least one local are network (LAN) to one wide area network (WAN), comprising:
an integrated firewall/VPN chipset configured to send and receive data packets between said WAN and said LAN and analyze access control functions based on said data packets, said chipset comprising a firewall portion configured to provide access control between said WAN and said LAN and a VPN portion configured to provide security functions for data between said LAN and said WAN; said firewall portion including firewall hardware and software portions wherein at least said firewall hardware portion is configured to provide iterative functions associated with said access control; said VPN portion including VPN hardware and software portions wherein at least VPN hardware portion is configured to provide iterative functions associated with said security functions.

2. The integrated firewall/VPN system as claimed in claim 1, wherein said chipset further comprises a router configured to route data between said LAN and said WAN.

3. The integrated firewall/VPN system as claimed in claim 1, wherein said firewall hardware portion comprising circuitry to provide static and/or dynamic data packet filtering.

4. The integrated firewall/VPN system as claimed in claim 3, wherein said circuitry includes a header match packet filtering circuit to provide pattern matching in selected headers of said data.

5. The integrated firewall/VPN system as claimed in claim 1, wherein said chipset further configured to analyze access control functions based on preselected bytes of said data packets.

6. The integrated firewall/VPN system as claimed in claim 5, wherein said preselected bytes comprise the first 144 bytes of said data packet.

7. The integrated firewall/VPN system as claimed in claim 1, wherein said VPN security functions comprise, encryption, decryption, encapsulation, and decapsulation of said data packets.

8. The integrated firewall/VPN system as claimed in claim 1, wherein said firewall access control functions comprise user-defined access control protocols.

9. A firewall/VPN integrated circuit (IC), comprising:
a router core configured to interface between at least one untrusted network and at least one trusted network to send and receive data packets between said untrusted and said trusted networks;
a firewall system configured to provide access control between said untrusted and said trusted networks, and comprising firewall hardware and software portions wherein at least said firewall hardware portion is configured to provide iterative functions associated with said access control and is configured to analyze access control functions on said data packets; and
a VPN engine configured to provide security functions for data between said untrusted and said trusted networks, and comprising VPN hardware and software wherein at least said VPN hardware portion is configured to provide iterative functions associated with said security functions.

10. The firewall/VPN integrated circuit (IC) as claimed in claim 9, wherein said firewall hardware portion comprising circuitry to provide static and/or dynamic data packet filtering.

11. The firewall/VPN integrated circuit (IC) as claimed in claim 10, wherein said circuitry includes a header match packet filtering circuit to provide pattern matching in selected headers of said data.

12. The firewall/VPN integrated circuit (IC) as claimed in claim 9, wherein said firewall system further configured to analyze access control functions based on preselected bytes of said data packets.

13. The firewall/VPN integrated circuit (IC) as claimed in claim 12, wherein said preselected bytes comprise the first 144 bytes of said data packet.

14. The firewall/VPN integrated circuit (IC) as claimed in claim 9, wherein said VPN security functions comprise encryption, decryption, encapsulation, and decapsulation of said data packets.

15. The firewall/VPN integrated circuit (IC) as claimed in claim 9, wherein said firewall access control functions comprise user-defined access control protocols.
